(19) United States
(12) Patent Application Publication
(10) Pub. No.: US 2010/0287907 A1
(43) Pub. Date: Nov. 18, 2010

(54) SYSTEM AND METHOD OF ESTIMATING A GAS TURBINE ENGINE SURGE MARGIN

(76) Inventors: Rajendra K. AGRAWAL, S. Windsor, CT (US); Ravi RAJAMANI, West Hartford, CT (US); William F. SCHNEIDER, Cromwell, CT (US); Coy Bruce WOOD, Ellington, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 12/468,013

(22) Filed: May 18, 2009

(51) Int. Cl. F02G 3/00; F02C 9/00

(52) U.S. Cl. 60/39.091; 60/39.24

(57) ABSTRACT

An example method of estimating a gas turbine engine surge margin and surge margin deterioration includes monitoring debris in at least a portion of an engine and establishing an estimated surge margin for the engine using information from the monitoring The method may use gas path parameters, such as pressures, temperatures, and speeds to establish the estimated surge margin. An example gas turbine engine surge margin assessment system includes a debris monitoring system configured to monitor debris moving through a portion of an engine, and a controller programmed to execute an engine deterioration model that establishes an estimated surge margin and loss in surge margin of the engine based on information from the debris monitoring system.

### BACKGROUND

This application relates generally to monitoring a gas turbine engine, and more particularly, to estimating a surge margin and surge margin deterioration for the engine using information from monitoring debris associated with the engine.

Gas turbine engines are known and typically include multiple sections, such as an inlet section, an inlet particle separation section, a fan section, a compression section, a combustor section, a turbine section, and an exhaust nozzle section. The fan section or the compression section moves air into the engine. The air is compressed as the air flows through the compression section. The compressed air is then mixed with fuel and combusted in the combustor section. Products of the combustion are expanded through turbine sections to rotatably drive the engine.

As known, the engine can surge, which undesirably destabilizes the engine. Referring to FIG. 1, a compressor map 2 shows a surge line 4 or stall line for a prior art engine. An engine operating point 6a having a pressure ratio and a flow rate above the surge line 4 will typically cause the engine to surge. An engine operating point 6b having a pressure ratio and a flow rate below the surge line 4 will typically not cause the engine to surge. The surge line 4 thus represents the boundary between unstable and stable engine operating points. An engine surge margin 8 is a measure of how close the engine operating point 6b is to the surge line 4. The surge margin 8 is thus a representation of how close the engine is to surge. Speed lines 9 show various combinations of pressure ratios and flow at a constant engine speed where the engine can operate stably below the surge line 4.

Components of the engine wear and erode during use, which can reduce the engine surge margin 8. Reductions in surge margin 8 reduces the ability of the engine to meet the pilot demand for increasing or decreasing thrust or power in response to throttle movements in acceptable time. The reductions are often due to increased running clearances of the components, erosion and loss of surface finish of the compressor airfoils and rematching of stages within the compression section and within the compression system and the turbine system, for example. Operating the engine at an operating point too close to the surge line 4 is undesirable as is known. Accordingly, technicians often repair, replace, and inspect the components to decrease the undesirable reductions in the engine surge margin 8 and to avoid the engine operating points near the surge line 4. Many engines operate in debris laden environments, such as engines that operate in sandy deserts. The debris from these environments can accelerate reductions in the engine surge margin 8 by accelerating wear and erosion of the components. The debris can also block component cooling holes by glassifying on the surfaces of engine components or by lodging within the cooling holes, which also has the effect of raising the engine operating line and reducing surge margin.

### SUMMARY

An example method of estimating a gas turbine engine surge margin includes monitoring debris in at least a portion of an engine and establishing an estimated surge margin for the engine using information from the monitoring. The method may use gas path parameters, such as pressures, temperatures, and speeds to establish the estimated surge margin.

Another example method of establishing an estimated gas turbine engine surge margin includes monitoring airflow moving through a portion of an engine to detect a presence of debris carried by the airflow, determining a characteristic of the debris, and changing an estimated surge margin of the engine based at least in part on the characteristic.

An example gas turbine engine surge margin assessment system includes a debris monitoring system configured to monitor debris moving through a portion of an engine, a monitoring system to assess the engine gas path parameters and a controller programmed to execute an engine deterioration model that establishes an estimated surge margin of the engine based on information from the debris monitoring system.

These and other features of the example disclosure can be best understood from the following specification and drawings, the following of which is a brief description.

### BRIEF DESCRIPTION OF THE DRAWINGS

FIG. 1 shows a prior art compressor map having a surge line.

FIG. 2 shows a partial schematic view of an example gas turbine engine and an example engine assessment system.

FIG. 3 shows a partial schematic view of an example turboshaft gas turbine engine and the engine assessment system.

FIG. 4 shows an example compressor map of the FIG. 2 engine.

FIG. 5 shows a schematic view of the engine assessment system of FIG. 2.

FIG. 6 schematically shows the flow of an example program for the engine assessment system of FIG. 2.

### DETAILED DESCRIPTION

FIG. 2 schematically illustrates an example turbofan gas turbine engine 10 including (in serial flow communication) an inlet section 12, a fan section 14, a low-pressure compressor 18, a high-pressure compressor 22, a combustor 26, a high-pressure turbine 30, a low-pressure turbine 34, and a exhaust nozzle section 36. The gas turbine engine 10 is circumferentially disposed about an engine centerline X. During operation, air A is pulled into the gas turbine engine 10 by the fan section 14, pressurized by the compressors 18 and 22, mixed with fuel, and burned in the combustor 26. The turbines 30 and 34 extract energy from the hot combustion gases flowing from the combustor 26. The residual energy is then expanded through the nozzle section to produce thrust.

In a two-spool design, the high-pressure turbine 30 utilizes the extracted energy from the hot combustion gases to power the high-pressure compressor 22 through a high speed shaft 38, and the low-pressure turbine 34 utilizes the extracted energy from the hot combustion gases to power the low-pressure compressor 18 and the fan section 14 through a low speed shaft 42.

The examples described in this disclosure are not limited to the two-spool engine architecture described and may be used in other architectures, such as a single-spool axial design, a three-spool axial design and a three spool axial and centrifugal design, and still other architectures. The examples described are also not limited to the turbofan gas turbine engine 10. For example, FIG. 3 schematically illustrates an example turboshaft gas turbine engine 10a including (in serial flow communication) an inlet section 12a, an inlet particle separator section 13a, a low-pressure compressor 18a, a high-pressure compressor 22a, a combustor 26a, a high-pressure turbine 30a, a low-pressure turbine 34a, and a power turbine section 35a. The inlet particle separator section 13a includes an inlet particle separator scroll 33a and a blower 39a as is known. A bypass flow of air moves through the blower 39a in this example.

The turbines 30a and 34a of the gas turbine engine 10a extract energy from the hot combustion gases flowing from the combustor 26a. The residual energy is expanded through the power turbine section 35a to produce output power that drives an external load 37, such as helicopter rotor system. Air is exhausted from the engine 10a at the exhaust nozzle section 36a. There are various types of engines, in addition to the turbofan gas turbine engine 10 of FIG. 2 and the turboshaft gas turbine engine 10a, that could benefit from the examples disclosed herein, which are not limited to the designs shown.

Referring again to FIG. 2, in this example, an engine assessment system 46 mounts to an aircraft 48 propelled by the gas turbine engine 10. The engine assessment system 46 is in operative communication with an inlet debris monitoring system 50, an engine gas path monitoring system 51, an aircraft monitoring system 53, a display device 54, and a variable vane section 58 of the low pressure compressor 18 and the high-pressure compressor 22. The engine assessment system 46 is programmed to estimate the surge margin for the compression systems based on the data from the inlet debris monitoring system 50, the engine gas path monitoring system 51, and the aircraft monitoring system 53.

The inlet debris monitoring system 50 receives information from debris detectors 52 that are mounted to the inlet section of the gas turbine engine 10. The debris detectors 52 are configured to measure a static charge 70 from debris 74 carried by the air A that is pulled into the gas turbine engine 10 by the compression section 22. In this example, the debris detectors 52 measure the static charge 70 of debris 74 within the fan section 14. Other examples include debris detectors 52 configured to measure the static charge 70 of debris 74 in other areas, such as forward the fan section 14 or in the low-pressure compressor 22.

The example debris monitoring system 50 provides the engine assessment system 46 with at least one characteristic of the debris 74. In this example, the debris monitoring system 50 quantifies the amount of the debris 74 entering the gas turbine engine 10 based on the amount of static charge 70. Other determinable characteristics include the type of the debris 74 carried by the air A. Sand is one example type of the debris 74. A person skilled in the art and having the benefit of this disclosure would be able to quantify the debris 74 or determine other characteristics of the debris 74 using the debris monitoring system 50.

Examples of the information provided to the engine assessment system 46 by the engine gas path monitoring system 51 include the speed, the temperature, and the pressure of air moving through the gas paths within the engine 10. Examples of the information provided to the engine assessment system 46 by the aircraft monitoring system 53 include aircraft altitude and aircraft speed.

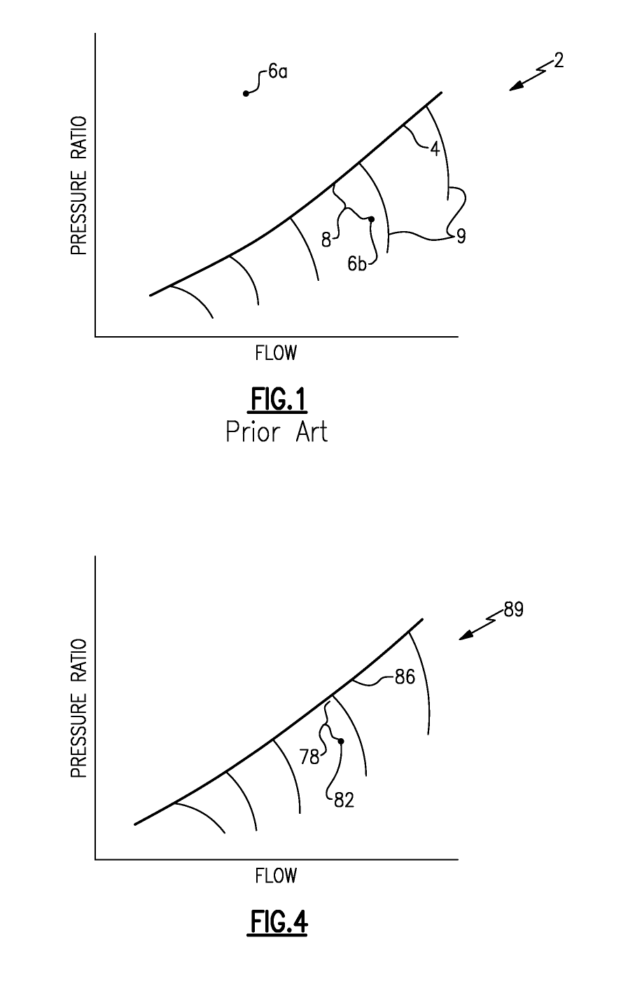

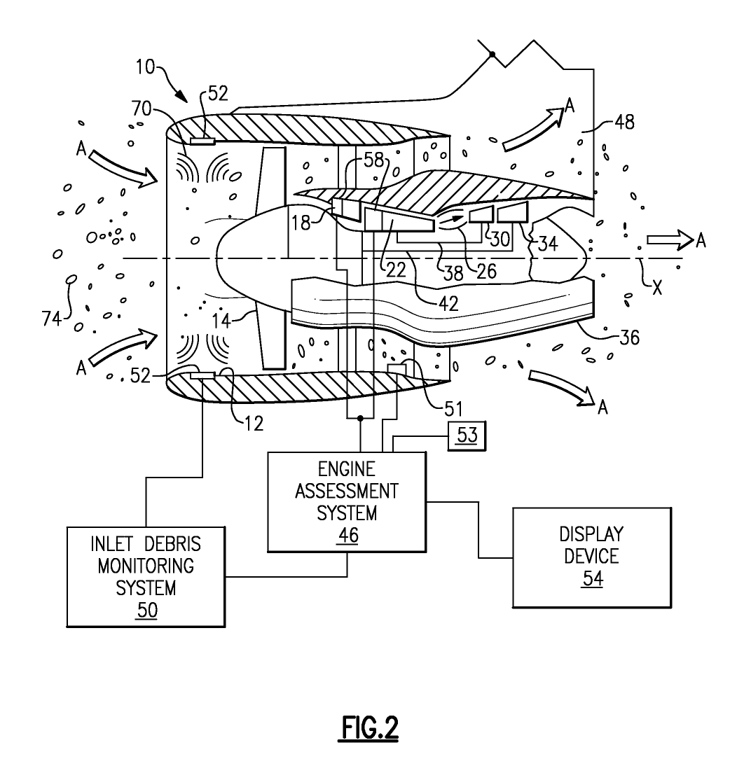

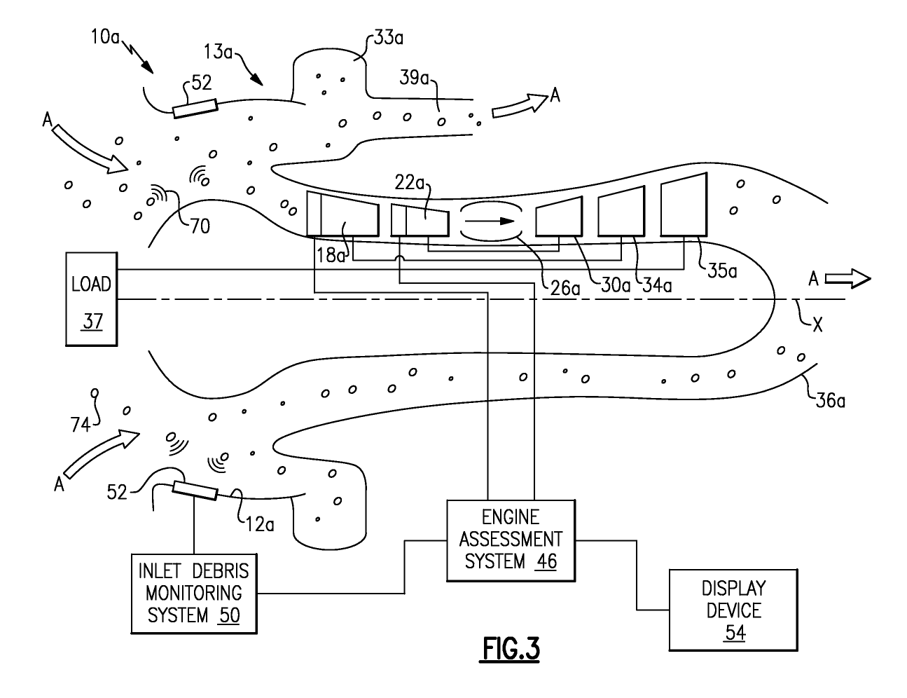

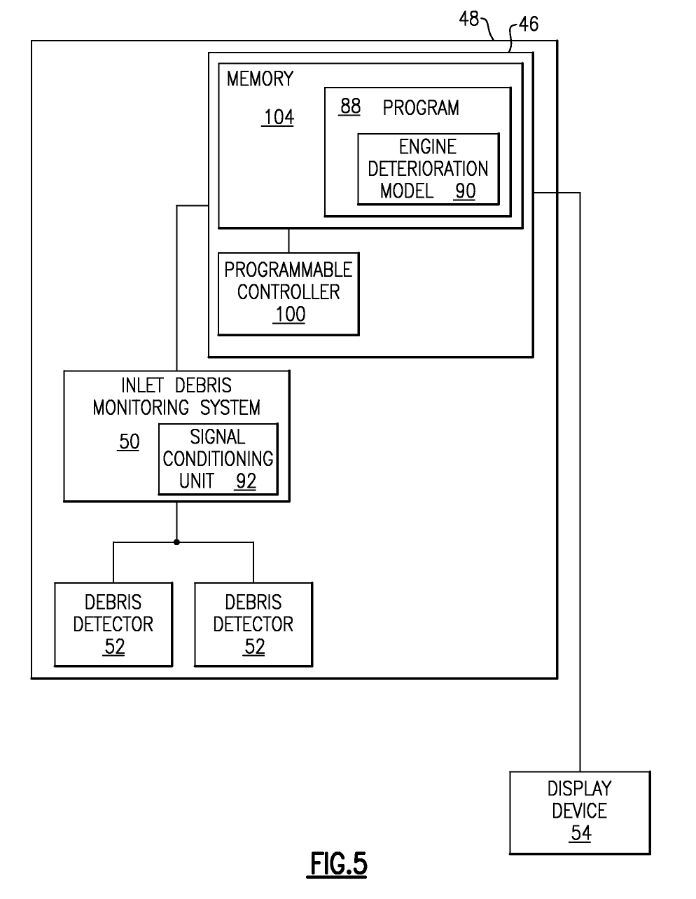

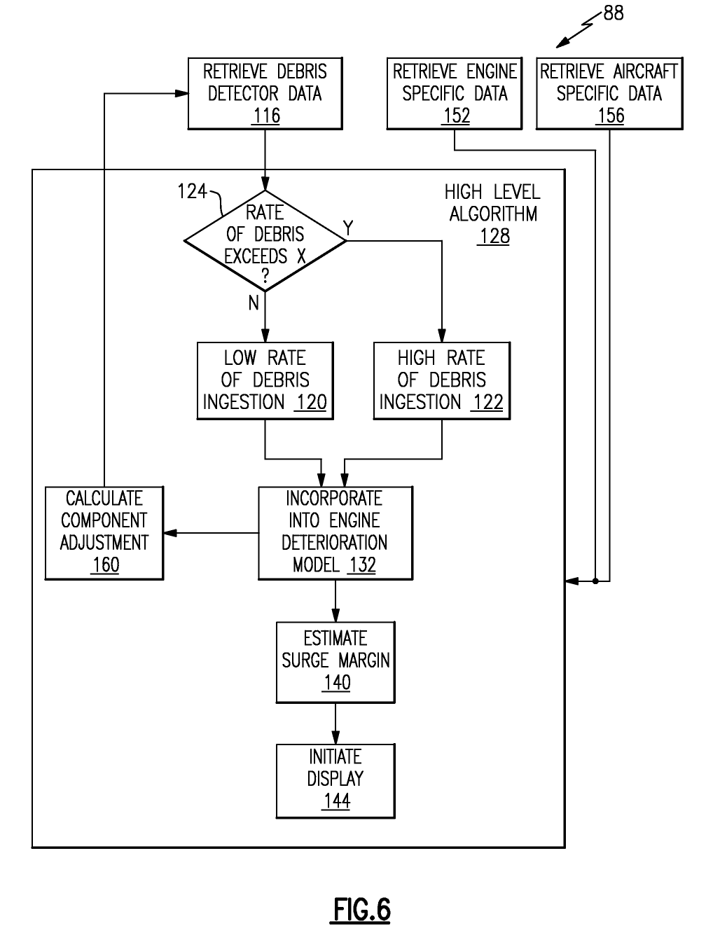

Referring to FIGS. 4-6 with continuing reference to FIG. 2, the example engine assessment system 46 uses the characteristics of the debris 74 and other gas path information to establish an estimate of the surge margin 78 for the engine 10, which is then compared to previous estimates, for example, to determine the deterioration in the surge margin 78 over time. The estimated surge margin 78 represents the distance between an engine operating point 82 and a surge line 86 of the engine 10. The estimated deterioration in surge margin 78 is due to component wear cause by debris 74 in the engine 10, for example. Losses in efficiency of the engine 10 can be calculated using such information. These efficiency losses are related to losses in the surge margin 78, which facilitates establishing the estimated surge margin 78. In another example, the engine assessment system 46 establishes the amount of deterioration in the surge margin 78, in addition to establishing the estimated surge margin 78.

In one example, the display device 54 is a computer monitor that displays the previously estimated undeteriorated surge margin and the deteriorated surge margin 78 on a compressor map 89 of the engine 10, for example. In another example, the estimated deterioration in surge margin 78 is displayed as a numerical value.

The vanes of the variable vane sections 58 are adjustable relative to flow of air through the gas turbine engine 10. Pneumatic or hydraulic actuators typically actuate the vane sections 58 based on a schedule. Operating the gas turbine engine 10 with the variable vane sections 58 in some positions, for example more open relative to a nominal vane schedule, lowers the impact of the debris 74 on the gas turbine engine 10, which slows undesirable reductions of the estimated surge margin 78 due to wearing, erosion, and blocked cooling holes. Changing the positions of other types of variable position components can also lower the impact of the debris 74 on the gas turbine engine 10.

The example engine assessment system 46 adjusts the variable vane sections 58 in response to the characteristics of the debris 74. In this example, the engine assessment system 46 adjusts the variable vane sections 58 when the debris detectors 52 detect that the fan section 14 (or for turboshaft engine 10a the compressor section 18a) is pulling large amounts of the debris 74 into the gas turbine engine 10. A sandy desert is one example of an environment likely to result in a large amount of the debris 74 entering the gas turbine engine 10. In other examples, the engine assessment system 46 adjusts other variable position components of the gas turbine engine 10 to positions that lower the impact of the debris 74 on the gas turbine engine 10.

The example engine assessment system 46 includes a programmable controller 100 and a memory portion 104. The example programmable controller 100 is programmed with an assessment program 88 that incorporates an engine deterioration model 90. In this example, the inlet debris monitoring system 50 includes a signal conditioning unit 92 that converts static charge measurement from the debris detectors 52 into a DC millivolt measurement. The assessment program 88, a type of computer program, uses the DC millivolt measurement to estimate the quantity and quality of the debris and provides this information to the engine deterioration model 90. The engine deterioration model 90 uses the debris data provided by the inlet debris monitoring system 50 with the measured gas path parameters to calculate the estimated surge margin 78, which is then displayed using the display device 54. In this example, the display device 54 is apart from the aircraft 48. In another example, the notification is inside the aircraft 48.

It should be noted that many computing devices can be used to implement various functionality, such as incorporating the characteristics of the debris 74 detected by the debris detectors 52 into the engine deterioration model 90. In terms of hardware architecture, such a computing device can include a processor, the memory portion 104, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor or controller 100 may be a hardware device for executing software, particularly software stored in the memory portion 104. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory portion 104 can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory portion 104 may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory portion 104, to communicate data to and from the memory portion 104, and to generally control operations of the computing device pursuant to the software. Software in memory, in whole or in part, is read by the processor, perhaps buffered within the processor, and then executed.

The example assessment program 88 for the programmable controller 100 includes a step 116 of retrieving the debris data from the inlet debris monitoring system 50. This debris data is provided to a high level algorithm 120. In one example, a low level algorithm (not shown) calculates the rate and type of the debris 74 entering the engine 10 and provides this debris data to the high level algorithm 120.

If the rate of the debris 74 does not exceed a value X in the step 124 in the high level algorithm 128, the program 88 progresses to a low rate leg 120 of the high level algorithm 128. If the rate of the debris 74 exceeds the value X in the step 124, the assessment program 88 progresses to a high rate leg 122 of the high level algorithm 128 for estimating the surge margin. In one example, the high level algorithm 128 moves to the high rate leg 122 of the high level algorithm 128 after determining that the engine 10 is ingesting more than one pound of sand per hour, and that the sand has a particular composition. The value X in a step 124 is thus one pound of sand that has the particular composition. The high level algorithm 128 moves to the low rate leg 120 when sand ingestion is below the value X to estimate engine surge margin for example.

The high level algorithm 128 includes a step 132 of incorporating the debris data from the step 124 into the engine deterioration model at the step 132. As known, the engine deterioration model facilitates establishing the appropriate timeframe for the periodic inspection.

The high level algorithm 128 estimates the surge margin at a step 140 in response to the debris amounts from the step 132. For example, if the debris data indicates that large amounts of debris are entering the engine 10, the high level algorithm 128 decreases the estimated surge margin 78.

The high level algorithm 128 also initiates a display on the display device 54 at a step 144. The display notifies a technician, for example, of a decrease in the estimated surge margin 78. The technician reacts to the decrease by accelerating time for replacements and repairs of the components of the engine 10 prior to the estimated surge margin 78 reaching 0. A pilot of the aircraft reviews the estimated surge margin 78 on the display device 54 during preflight checks in another example.

In one example, the high level algorithm 128 utilizes information about the size of the debris 74 moving through the engine 10 when establishing the estimated surge margin. For example, the estimated loss of surge margin 78 relative to undeteriorated engine associated with fine debris is less severe than the loss associated with course debris.

The example high level algorithm 128 and particularly the engine deterioration model at the step 132 utilizes additional data to determine the current estimated surge margin 78 and the loss of surge margin relative to as new undeteriorated engine. For example, a step 152 provides the high level algorithm 128 with engine specific data, such as engine speeds, engine pressures, etc. A step 156 provides the high level algorithm 128 with aircraft specific data, such as flight speeds, flight altitudes, etc.

At a step 160, the high level algorithm 128 calculates and initiates adjustments to variable position components of the engine 10. The high level algorithm 128 initiates changes the positions of variable position components, such as the variable vane sections 58 of the engine 10 to lower the impact of the debris 74 on other components of the engine 10. The high level algorithm 128 initiates changes by initiating pneumatic actuators to move the variable position components, for example. In one example, scheduling the vanes more open relative to the nominal vane schedules reduces the loss in surge margin due to the coarse sand debris ingestion. Lowering the impact of the debris 74 on the components of the engine 10 slows reductions in the estimated surge margin 78 and increase engine availability.

Features of the disclosed examples include establishing an estimated surge margin for a gas turbine engine based on debris entering the engine and the measured gas path parameters such as pressures, temperatures and speeds.

Although a preferred embodiment has been disclosed, a worker of ordinary skill in this art would recognize that certain modifications would come within the scope of this invention. For that reason, the following claims should be studied to determine the true scope and content of this invention.

We claim:

1. A method of estimating a gas turbine engine surge margin comprising:
monitoring debris in at least a portion of an engine; and
establishing an estimated surge margin for the engine using information from the monitoring.

2. The method of claim 1 including monitoring at least one of a pressure, a temperature, or a speed of a gas moving through a gas path.

3. The method of claim 1 including adjusting a variable component of the engine to lessen the debris effect on the engine.

4. The method of claim 3 wherein the adjusting includes actuating a plurality of compressor variable vanes.

5. The method of claim 1 including performing a maintenance action on the engine prior to the estimated surge margin reaching a value below an established threshold value.

6. The method of claim 1 wherein the monitoring includes quantifying the debris.

7. The method of claim 1 including incorporating information from the monitoring into an engine deterioration model and establishing the estimated surge margin using the engine deterioration model.

8. The method of claim 1 wherein the establishing comprises determining a loss in an estimated surge margin relative to a nominal undeteriorated engine.

9. The method of claim 1 including using an engine deterioration model for said establishing.

10. A method of establishing an estimated gas turbine engine surge margin comprising:
monitoring airflow moving through a portion of an engine to detect a presence of debris carried by the airflow;
determining a characteristic of the debris; and
changing an estimated surge margin of the engine based at least in part on the characteristic.

11. The method of claim 10 wherein the changing comprises establishing a loss of engine surge margin.

12. The method of claim 11 including adjusting at least one component of the engine in response to the characteristic to decrease the loss of engine surge margin.

13. The method of claim 10 wherein the characteristic comprises an amount of debris.

14. The method of claim 10 wherein the characteristic comprises a type of debris.

15. The method of claim 10 wherein the portion of the engine comprises an area extending forward a fan section of the engine.

16. A gas turbine engine surge margin assessment system comprising:
a debris monitoring system configured to monitor debris moving through a portion of an engine; and
a controller programmed to execute an engine deterioration model that establishes a estimated surge margin of the engine based on information from the debris monitoring system.

17. The system of claim 16 wherein an engine deterioration model establishes the estimated surge margin of the engine.

18. The system of claim 16 wherein the controller is programmed to adjust at least one component of the engine to decrease reductions in the estimated surge margin in response to the debris monitoring system.
